(19) United States
(12) Patent Application Publication
(10) Pub. No.: US 2007/0230431 A1
(43) Pub. Date: Oct. 4, 2007

(54) Methods and Apparatus for Backwards Compatible Communication in a Multiple Antenna Communication System Using Fmd-Based Preamble Structures

(76) Inventors: Bas Driesen, Dongen (NL); Ra'anan Gil, Nieuwegein (NL)

Correspondence Address: RYAN, MASON & LEWIS, LLP, 1300 POST ROAD, SUITE 205, FAIRFIELD, CT, 06824, US

(21) Appl. No.: 10/562,617

(22) PCT Filed: Jun. 30, 2004
(86) PCT No.: PCT/US04/21027

§ 371 Date: May 23, 2007

Related U.S. Application Data
(60) Provisional application No. 60/483,719, filed on Jun. 30, 2003.
(60) Provisional application No. 60/538,567, filed on Jan. 23, 2004.

(51) Int. Cl. H04J 3/00

(52) U.S. Cl. 370/345

(57) ABSTRACT

A method and apparatus are disclosed for transmitting symbols in a multiple antenna communication system according to a frame structure, such that the symbols can be interpreted by a lower order receiver (i.e., a receiver having a fewer number of antennas than the transmitter). The disclosed frame structure comprises a legacy preamble having at least one long training symbol and N-I additional long training symbols that are transmitted on each of N transmit antennas. The legacy preamble may be, for example, an 802.11 a/g preamble that includes at least one short training symbol, at least one long training symbol and at least one SIGNAL field. A sequence of each of the long training symbols on each of the N transmit antennas are time orthogonal. The long training symbols can be time orthogonal by introducing a phase shift to each of long training symbols relative to one another.

### CROSS REFERENCE TO RELATED APPLICATIONS

This application claims the benefit of United States Provisional Application No. 60/483,719, filed Jun. 30, 2003, and United States Provisional Application No. 60/538,567, filed Jan. 23, 2004, each incorporated by reference herein. The present application is also related to United States Patent Application, entitled “Method and Apparatus for Communicating Symbols in a Multiple Input Multiple Output Communication System Using Diagonal Loading of Subcarriers Across a Plurality of Antennas,” United States Patent Application, entitled “Methods and Apparatus for Backwards Compatible Communication in a Multiple Input Multiple Output Communication System with Lower Order Receivers,” and United States Patent Application entitled “Methods and Apparatus for Backwards Compatible Communication in a Multiple Antenna Communication System Using Time Orthogonal Symbols,” each filed contemporaneously herewith and incorporated by reference herein.

### FIELD OF THE INVENTION

The present invention relates generally to wireless communication systems, and more particularly, to frame structures that allow channel estimation for a multiple antenna communication system.

### BACKGROUND OF THE INVENTION

Most existing Wireless Local Area Network (WLAN) systems based upon OFDM modulation comply with either the IEEE 802.11 a or IEEE 802.11 g standards (hereinafter “IEEE 802.11 a/g”). See, e.g., IEEE Std 802.11 a-1999, “Part 11: Wireless LAN Medium Access Control (MAC) and Physical Layer (PHY) Specification: High-Speed Physical Layer in the Five GHz Band,” incorporated by reference herein. In order to support evolving applications, such as multiple high-definition television channels, WLAN systems must be able to support ever increasing data rates. Accordingly, next generation WLAN systems should provide increased robustness and capacity.

Multiple transmit and receive antennas have been proposed to provide both increased robustness and capacity. The increased robustness can be achieved through techniques that exploit the spatial diversity and additional gain introduced in a system with multiple antennas. The increased capacity can be achieved in multipath fading environments with bandwidth efficient Multiple Input Multiple Output (MIMO) techniques.

A MIMO-OFDM system transmits separate data streams on multiple transmit antennas, and each receiver receives a combination of these data streams on multiple receive antennas. The difficulty, however, is in distinguishing between and properly receiving the different data streams at the receiver. A variety of MIMO-OFDM decoding techniques are known, but they generally rely on the availability of accurate channel estimations. For a detailed discussion of MIMO-OFDM decoding techniques, see, for example, P. W. Wolniansky at al., “V-Blast: An Architecture for Realizing Very High Data Rates Over the Rich-Scattering Wireless Channel,” 1998 URSI International Symposium on Signals, Systems, and Electronics (Sept., 1998), incorporated by reference herein.

In order to properly receive the different data streams, MIMO-OFDM receivers must acquire a channel matrix through training. This is generally achieved by using a specific training symbol, or preamble, to perform synchronization and channel estimation techniques. The training symbol increases the total overhead of the system. In addition, a MIMO-OFDM system needs to estimate a total of NₜNᵣ channel elements, where Nₜ is the number of transmitters and Nᵣ is the number of receivers, which could lead to an Nₜ increase of the long training length.

A need therefore exists for a method and system for performing channel estimation and training in a MIMO-OFDM system utilizing a signal that is orthogonal in either the frequency domain or the time domain. A further need exists for a method and system for performing channel estimation and training in a MIMO-OFDM system that is compatible with current IEEE 802.11 a/g standard (SISO) systems, allowing MIMO-OFDM based WLAN systems to efficiently co-exist with SISO systems.

### SUMMARY OF THE INVENTION

Generally, a method and apparatus are disclosed for transmitting symbols in a multiple antenna communication system according to a frame structure, such that the symbols can be interpreted by a lower order receiver (i.e., a receiver having a fewer number of antennas than the transmitter). The disclosed frame structure comprises a legacy preamble having at least one long training symbol and at least one additional long training symbol transmitted on each of N transmit antennas. The legacy preamble may be, for example, an 802.11 a/g preamble that includes at least one short training symbol, at least one long training symbol and at least one SIGNAL field.

The subcarriers of the long training symbols are grouped into a plurality of subcarrier groups, and each subcarrier group is transmitted on a different transmit antenna in a given time interval. The grouping of the subcarriers may be based, for example, on blocking or interleaving techniques. Each transmit antenna transmits N long training symbols. The subcarrier groups transmitted by a given transmit antenna are varied for each of the N long training symbols transmitted by the given transmit antenna, such that each transmit antenna transmits each subcarrier of the long training symbols only once.

According to one aspect of the invention, a sequence of each of the long training symbols on each of the N transmit antennas are orthogonal in the frequency domain. In this manner, a transmitter in accordance with the present invention may be backwards compatible with a lower order receiver and a lower order receiver can interpret the transmitted symbols and defer for an appropriate duration.

A more complete understanding of the present invention, as well as further features and advantages of the present invention, will be obtained by reference to the following detailed description and drawings.

### BRIEF DESCRIPTION OF THE DRAWINGS

FIG. 1 illustrates a conventional multiple antenna communication system consisting of Nₜ transmitters, Nᵣ receivers;

FIG. 2 illustrates a conventional long training symbol according to the IEEE 802.11 a/g standard consisting of 64 subcarriers, seen at the input of the Inverse Fast Fourier Transform (IFFT);

FIG. 3 illustrates a frequency domain representation of a conventional IEEE 802.11 a/g long training symbol;

FIG. 4 illustrates a conventional IEEE 802.11 a/g preamble structure;

FIG. 5 illustrates an FDM-based preamble structure incorporating features of the present invention for an exemplary implementation having two transmit antennas;

FIG. 6 illustrates an FDM-based preamble structure incorporating features of the present invention for an exemplary implementation having Nₜ transmit antennas;

FIG. 7 illustrates FDM long training symbols in accordance with a blocked subcarrier grouping implementation of the invention;

FIG. 8 illustrates FDM long training symbols in accordance with an interleaved subcarrier grouping implementation of the invention;

FIG. 9 is a block diagram of an exemplary MIMO-OFDM receiver incorporating features of the present invention; and

FIGS. 10A and 10B illustrate the channel estimation before and after rearrangement of the frequency blocks by the receiver, respectively.

### DETAILED DESCRIPTION

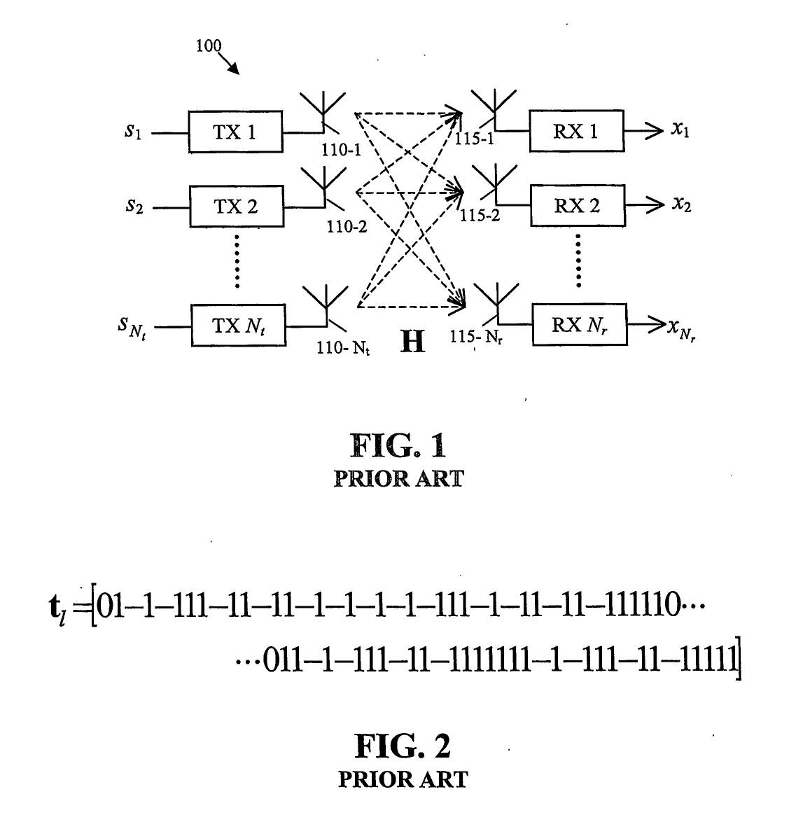

The present invention is directed to a backwards compatible MIMO-OFDM system. The disclosed frame structure comprises a legacy preamble having at least one long training symbol and at least one additional long training symbol transmitted on each of N transmit antennas. It is noted that in an IEEE 802.11 a/g implementation, each long training symbol comprises two equivalent symbols. FIG. 1 illustrates an exemplary MIMO-OFDM system 100 comprising source signals S₁ to SNₜ, transmitters TRANSMIT₁ to TRANSMIT_{Nt}, transmit antennas 110-1 through 110-Nₜ, receive antennas 115-1 through 115-Nᵣ, and receivers RX₁ to RX_{Nr}. The MIMO-OFDM system 100 transmits separate data streams on the multiple transmit antennas 110, and each receiver RX receives a combination of these data streams. In order to extract and detect the different data streams S₁ to S_{Nt}, the MIMO-OFDM receivers RX must acquire the channel matrix, H, as shown in FIG. 1, through training.

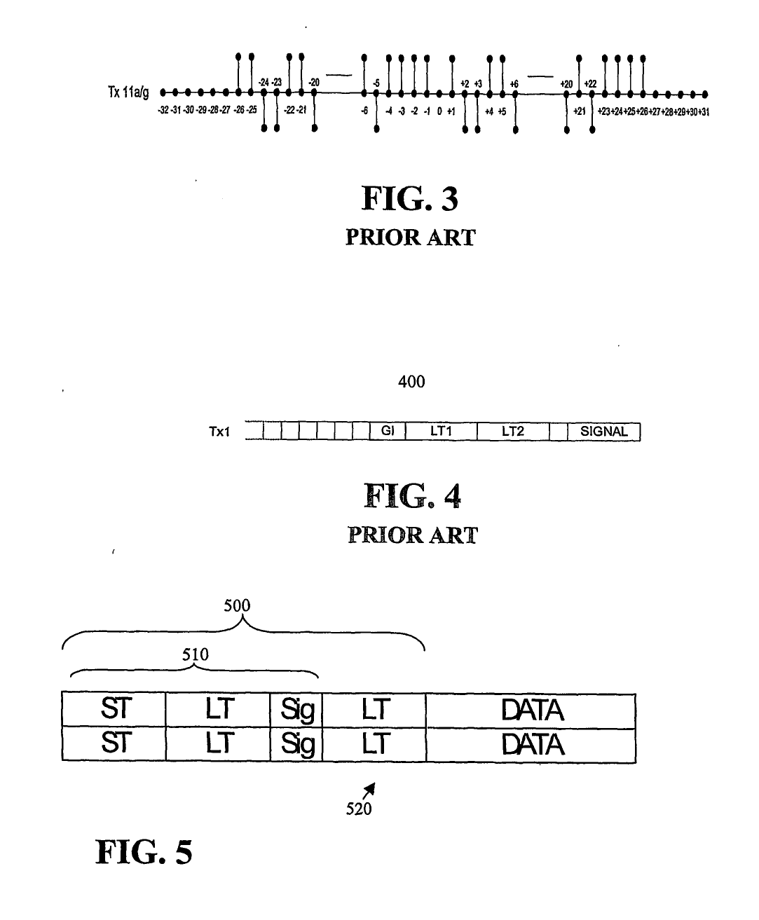

The IEEE 802.11 a/g standard specifies a preamble in the frequency domain for OFDM-based Wireless Local Area Network systems consisting of short and long training symbols. The short training symbols can be used for frame detection, Automatic Gain Control (AGC) and coarse synchronization. The long training symbols can be used for fine synchronization and channel estimation. The long training symbol according to the IEEE 802.11 a/g standard consists of 64 subcarriers of which 52 subcarriers are actually used and is specified as shown in FIG. 2. FIG. 3 illustrates a frequency domain representation of the IEEE 802.11 a/g long training symbol of FIG. 2.

The ideal training symbol for a MIMO-OFDM system is orthogonal in the frequency domain or in the time domain. According to one aspect of the present invention, the long training symbol of the IEEE 802.11 a/g standard is made frequency orthogonal by dividing the various subcarriers of the long training symbols across the different transmit antennas.

### Backwards Compatibility

A MIMO-OFDM system preferably needs to be backwards compatible to the current IEEE 802.11 a/g standard in order to coexist with existing systems, since they will operate in the same shared wireless medium. The use of an IEEE 802.11 a/g long training symbol in a MIMO-OFDM system as disclosed herein provides for a MIMO-OFDM system that is backwards compatible and that can coexist with IEEE 802.11 a/g systems and MIMO-OFDM systems of other orders (i.e., comprising a different number of receivers/transmitters). As used herein, backwards compatibility means that a MIMO-OFDM system needs to be able to (i) support the current standards; and (ii) (optionally) defer (or standby) for the duration of a MIMO-OFDM transmission. Any system with Nᵣreceive antennas or another number of receive antennas that is not able to receive the data transmitted in a MIMO format is able to defer for the duration of the transmission since it is able to detect the start of the transmission and retrieve the length (duration) of this transmission, which is contained in the SIGNAL field following the long training symbols.

A MIMO-OFDM system 100 employing a long training symbol can communicate in a backwards-compatible way with an IEEE 802.11 a/g system in two ways. First, it is possible to scale back to one antenna to transmit data according to the IEEE 802.11 a/g standard. Secondly, the IEEE 802.11 a/g receiver is able to interpret the MIMO transmission from all the active transmitters as a normal OFDM frame. In other words, an IEEE 802.11 a/g receiver can interpret a MIMO transmission of data, in a manner that allows the IEEE 802.11 a/g receiver to defer for the duration of the MIMO transmission. For a more detailed discussion of a suitable deferral mechanism, see, for example, United States Patent Application, entitled “Methods and Apparatus for Backwards Compatible Communication in a Multiple Input Multiple Output Communication System with Lower Order Receivers,” incorporated by reference herein.

A MIMO system that uses at least one long training field of the IEEE 802.11 a/g preamble structure repeated on different transmit antennas can scale back to a one-antenna configuration to achieve backwards compatibility. A number of variations are possible for making the long training symbols orthogonal. In one variation, the long training symbols can be diagonally loaded across the various transmit antennas, in the manner described above. In another variation, 802.11 a long training sequences are repeated in time on each antenna. For example, in a two antenna implementation, a long training sequence, followed by a signal field is transmitted on the first antenna, followed by a long training sequence transmitted on the second antenna. A further variation employs MIMO-OFDM preamble structures based on orthogonality in the time domain.

According to one aspect of the present invention, the subcarriers of the long training symbols are divided into Nₜgroups (where Nₜis the number of transmit branches) and each subcarrier group is transmitted on a different transmit antenna in a given time slot. The subcarriers of the long training symbol can be divided into Nₜ separate subcarrier groups in various ways. In various embodiments discussed herein, the subcarriers are grouped using blocking or interleaving techniques. It is noted the size of each of the Nₜ groups does not need to be equal.

In one exemplary implementation that is backwards compatible with legacy WLAN systems, the long training symbols are based on the frequency domain content of IEEE 802.11 a/g long training symbols. The disclosed scheme uses Nₜ long training symbols, where Nₜ is the number of transmit antennas in the system. The frequency domain orthogonality can be achieved, for example, by dividing the frequency-domain content of the 52 frequency bins in the 802.11 a/g long training symbol 510 into Nₜ groups. Thus, the aggregate signal received by a receiver will be an 802.11 a/g long training symbol 510, as well as the additional long training symbols 520 (which can be ignored, if not understood by a lower order receiver).

FIG. 5 illustrates an FDM-based preamble structure 500 incorporating features of the present invention for an exemplary implementation having two transmit antennas. The FDM-based preamble structure 500 is based on the orthogonality in frequency domain. In the exemplary two transmit antenna implementation, the FDM-based preamble structure 500 comprises grouping half of the subcarriers of the first long training symbol for the first transmitter and grouping the remaining half of the subcarriers of the first long training symbol for the second transmitter. This process is then inverted for the second long training symbol. It is noted that the SIGNAL-field needs to be transmitted in the same way as the first long training symbol in order to be backwards compatible.

The different transmit antennas will use distinct groups of different subcarriers to construct each long training symbol in order to maintain orthogonality. Each transmit antenna will cyclically shift to the next subcarriers group to construct the following long training signal. This continues until the last long training symbol (number Nₜ) is constructed. In this manner, frequency-orthogonality is maintained for each long training symbol, while each transmit antenna covers the complete frequency range at the end of the process to support channel estimation of the complete channel from all the transmitters to all the receivers.

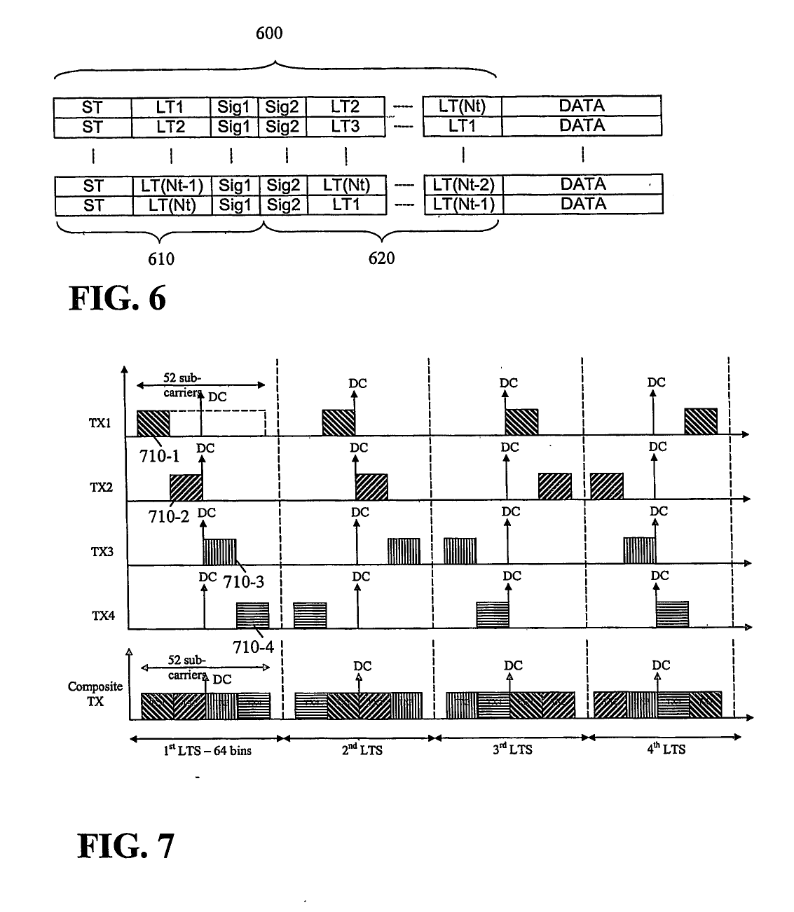

FIG. 6 illustrates an FDM-based preamble structure 600 incorporating features of the present invention for an exemplary implementation having Nₜ transmit antennas. The exemplary preamble structure 600 includes two SIGNAL fields that contain the necessary additional information when more than one transmit antenna is used. It is noted that the construction of the long training symbol is done by applying IFFT, cyclic prefix and windowing as described in the IEEE802.11 a/g standard. It is further noted that as the IFFT operation is linear, the composite time domain long training signals sent by all Nₜ transmitters will be equal to a time-domain long training signals sent by a single antenna in case of a SISO-OFDM system.

Blocked Subcarrier Groups

FIG. 7 illustrates FDM long training symbols in accordance with a blocked subcarrier grouping implementation of the present invention. As shown in FIG. 7, each long training symbol in the exemplary embodiment includes 52 active subcarriers that are divided into Nₜ groups. In the blocked subcarrier grouping implementation of the present invention, the subcarriers are group based on consecutive or adjacent subcarriers. In the illustrative embodiment, each group of subcarriers contains 13 {52/Nₜ} adjacent sub-carriers for Nₜ equal to four (4).

As shown in FIG. 7, the first long training symbol is divided into four subcarrier groups 710-1 through 710-4 (each containing 13 adjacent subcarriers). According to another feature of the long training symbol scheme of the present invention, the subcarrier group that is transmitted by a given transmit branch is varied for each of the N long training symbols, such that after transmission of the N long training symbols, each transmit branch, TXₙ, has transmitted each subcarrier of the long training symbol once and only once. In other words, for the first transmit branch, TX1, the first subcarrier group is transmitted in the first long training symbol, the second subcarrier group is transmitted in the second long training symbol, the third subcarrier group is transmitted in the third long training symbol, and the fourth subcarrier group is transmitted in the fourth long training symbol. Similarly, for the second transmit branch, TX2, the second subcarrier group is transmitted in the first long training symbol and so on, as shown in FIG. 7.

For an even number of transmit branches, all groups will have the same number of subcarriers (equal to 52/Nₜ), while for an odd number of transmit branches, not all groups will have the same number of subcarriers, but rather a number close to 52/Nₜ, still keeping frequency-domain orthogonality and altogether containing all 52 subcarriers.

If the legacy long training symbol in frequency domain using 52 out of the 64 subcarriers is as shown in FIG. 2, then the long training symbols for the m^{th} long training symbol transmitted from the n^{th} transmit antenna in case of a four transmit antenna MIMO system, would be expressed as follows:

$$\begin{matrix}{t}_{l}^{{P}_{n m} = 0} = [ \overbrace{0 … 0}^{38} 11 - 1 - 111 - 11 - 11111 \overbrace{0 …0}^{13} ] & ( 1 ) \\ {t}_{l}^{{P}_{n m} = 1} = [ \overbrace{0 … 0}^{38} 11 - 1 - 111 - 11 - 11111 ] & ( 2 ) \\ {t}_{l}^{{P}_{n m} = 2} = [ 01 - 1 - 111 - 11 - 11 - 1 - 1 - 1 - 1 \overbrace{0 … 0}^{50} ] & ( 3 ) \\ {t}_{l}^{{P}_{n m} = 3} = [ \overbrace{0 … 0}^{14} - 111 - 1 - 11 - 11 - 11111 \overbrace{0 …0}^{37} ] & ( 4 )\end{matrix}$$

where Pₙₘ is the subcarrier group number (0 to Nₜ-1) given by:
_{P}ₙₘ=[(ₙ₋1)+(ₘ₋1)] mod _{N}ₜ (5)
where n is the transmit antenna index (1. . . Nₜ) and in is the long training symbol number (1. . . Nₜ).

Interleaved Subcarrier Groups

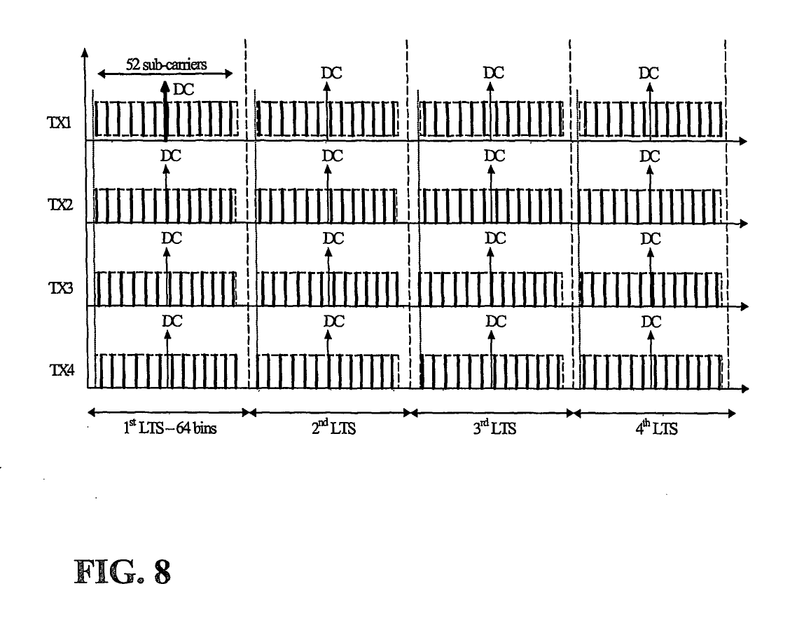

FIG. 8 illustrates FDM long training symbols in accordance with an interleaved subcarrier grouping implementation of the present invention. As shown in FIG. 8, each long training symbol in the exemplary embodiment includes 52 active subcarriers that are divided into Nₜ groups. In the interleaved subcarrier grouping implementation of the present invention, the subcarriers are group based on a pattern that includes every Nₜ'th subcarrier. For example, in a four transmit branch implementation, the 1^{st}, 5^{th}, 9^{th}, and 49^{th} subcarriers would be included in a first subcarrier group. In the illustrative embodiment, each group of subcarriers contains 13 {52/Nₜ} sub-carriers (for Nₜ equal to four (4)), where each subcarrier in a group is separated by Nₜ. In this manner, the subcarriers of all Nₜ groups are interleaved.

The long training symbol scheme of the present invention supports any number of transmit antennas, subcarriers, bandwidth constraints and grouping schemes, as would be apparent to a person of ordinary skill in the art.

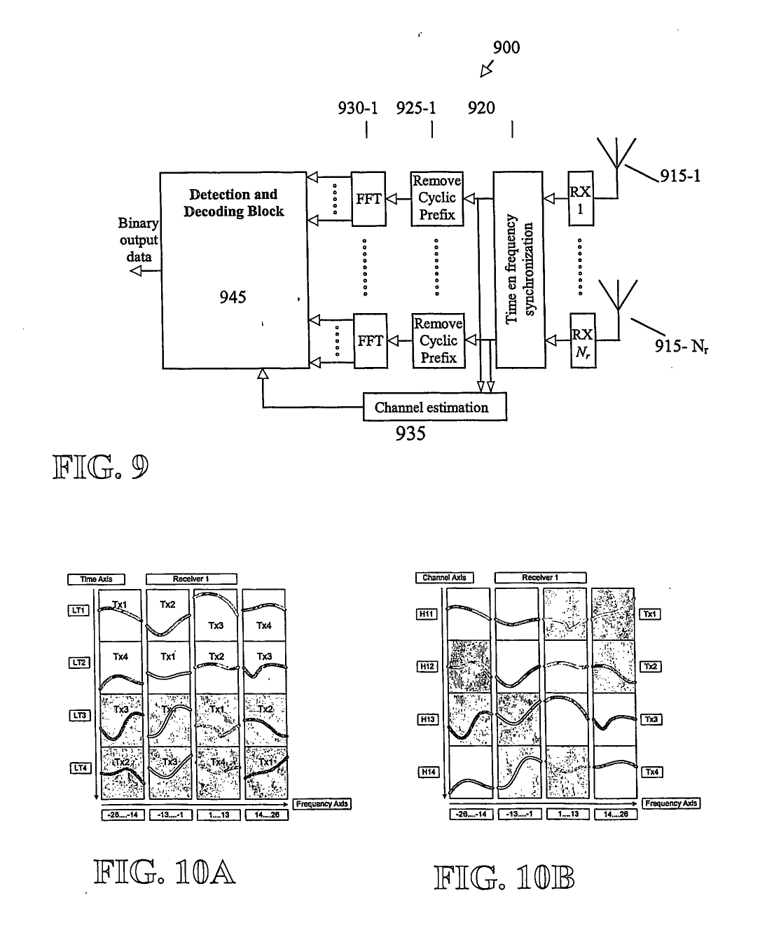

FIG. 9 is a block diagram of an exemplary MIMO-OFDM receiver 900 incorporating features of the present invention. As shown in FIG. 9, the MIMO-OFDM receiver 900 includes a plurality of receive antennas 915-1 through 915-Nᵣ, and receive branches RX₁ to RX_{N}_{ᵣ}. Time and frequency synchronization is performed at stage 920, and the synchronized received signal is applied to stage 925 that removes the cyclic prefix and a channel estimation stage 935. Once the cyclic prefix is removed at stage 925, a fast fourier transform (FFT) is performed at stage 930. A detection and decoding block 945 performs MIMO detection (for N_{c} subcarriers), phase drift and amplitude droop correction, demapping, deinterleaving, depunturing and decoding, using the channel estimate 935.

The MIMO-OFDM receiver 900 can perform backwards compatible channel estimation 935 with FDM long training symbols and detection of the SIGNAL-field as follows:

1. adding the two long training symbols (LTS) of the first long training (LT) to gain 3 dB in SNR;

2. transforming the resulting long training symbol to the frequency domain;

3. demodulation of the long training symbol, resulting in the partial channel estimates;

4. transforming the SIGNAL-field to the frequency domain;

5. detection and decoding of the SIGNAL-field using the partial channel estimates;

6. demodulation of the SIGNAL-field to obtain another estimate of the partial channels;

7. summing and scaling the demodulated SIGNAL-field to the demodulated training symbol (adding up the incomplete channel estimates) additionally gains 1.8 dB in SNR;

8. performing steps 1 to 3 for the remaining long training sequences (LT);

9. performing steps 4 to 7 in case of any long training sequence, which is followed by an additional SIGNAL-field; and

10. adding all partial channels' estimations to get to the complete channels' estimations.

Channel estimation is done at the MIMO-OFDM receiver side and takes place after timing and frequency synchronization. At the receiver, each of the Nᵣ MIMO-OFDM receivers would be able to compose the actual channel estimation to all Nₜ transmit antennas based on a-priori knowledge of the FDM long training scheme used by the transmitter. Each receiver processes each long training symbol in a similar manner to the SISO-OFDM case, using FFT and subcarrier demodulation to extract a distinct part of each channel belonging to the different transmitters. The next step would be collecting the channel parts belonging to the same transmitter in order to compose the complete channel for every transmitter. An example for a four transmit antenna MIMO system is given below.

In general, the MIMO received signal in the frequency domain per subcarrier can be expressed in a matrix vector notation as follows:
r=Hs+n (6)

For a 4×4 MIMO system the matrix vector notation would be expressed as follows:

$$[ \begin{matrix}{r}_{1} \\ {r}_{2} \\ {r}_{3} \\ {r}_{4}\end{matrix} ] = [ \begin{matrix}{H}_{11} & {H}_{12} & {H}_{13} & {H}_{14} \\ {H}_{21} & {H}_{22} & {H}_{23} & {H}_{24} \\ {H}_{31} & {H}_{32} & {H}_{33} & {H}_{34} \\ {H}_{41} & {H}_{42} & {H}_{43} & {H}_{44}\end{matrix} ] \cdot [ \begin{matrix}{s}_{1} \\ {s}_{2} \\ {s}_{3} \\ {s}_{4}\end{matrix} ] + [ \begin{matrix}{n}_{1} \\ {n}_{2} \\ {n}_{3} \\ {n}_{4}\end{matrix} ] \qquad ( 7 )$$

The process taken by each receiver to construct the channel estimation matrix H for each subcarrier out of all received FDM long trainings is shown in FIGS. 10A and 10B for the first receiver. FIG. 10A illustrates the channel estimation before rearrangement of the frequency blocks by the receiver. FIG. 10B illustrates the channel estimation after rearrangement of the frequency blocks by the receiver. In FIGS. 10A and 10B, the frequency axis is divided into the same Nₜ subcarrier grouping employed by the transmitter (see FIGS. 7 and 8) and the time axis is divided into the same Nₜ time slots to support the transmission of Nₜ long training symbols.

The preamble can be made backwards compatible with current 802.11 a/g-based systems. In order to be backwards compatible, 802.11 a/g based systems needs to be able to detect the preamble and interpret the packet's SIGNAL-field. This is achieved using the same FDM scheme used for the first long training symbol as well for the SIGNAL-field transmission from the different transmit antennas. The length specified in the SIGNAL-field for a MIMO transmission should be made equal to the actual duration of the packet, so that an 802.11 a/g based system could then defer for the duration of the MIMO transmission. A MIMO system needs to be able to translate this into the actual length of the packet in bytes. For this, a MIMO system has to have additional information, which can be included in the reserved bit in the SIGNAL-field, or in a separate additional second SIGNAL field (see FIG. 6) that might be unavoidable in a backward compatible WLAN MIMO-OFDM system.

For a more detailed discussion of a suitable deferral mechanism, see, for example, United States Patent Application, entitled “Methods and Apparatus for Backwards Compatible Communication in a Multiple Input Multiple Output Communication System with Lower Order Receivers,” incorporated by reference herein.

Furthermore a MIMO-OFDM system based on FDM long training symbols and SIGNAL-field can be made scalable to different MIMO configurations. For example, a MIMO-OFDM system with three transmit antennas can easily be scaled back to a MIMO-OFDM system with two transmit antennas. Additionally a MIMO-OFDM system with only two receive antennas can train the channel and interpret the SIGNAL-field of a MIMO-OFDM transmission with three transmit antennas, and therefore is able to defer for the duration of the packet. A MIMO-OFDM system is then coexistent with 802.11 a/g systems and lower order MIMO-OFDM systems. With coexistence is meant, any system with Nᵣreceive antennas that is not able to receive the data transmitted, is able to defer for the duration of the transmission, because it is able to detect the start of the transmission and retrieve the length (duration) of this transmission from its SIGNAL-field. Furthermore a MIMO-OFDM system is able to communicate in a backwards-compatible way to an 802.11 a/g system in two ways. First, it is possible to scale back the system to one antenna. Second, it is possible to load the data on the different antennas in a FDM fashion as well.

A FDM SIGNAL-field has another benefit, namely, it can be used to serve as a third long training symbol. The SIGNAL-field is always modulated and encoded in the same robust way, which facilitates good reception. The SIGNAL-field in a MIMO transmission is even more robust, as the SIGNAL-field is received by multiple antennas and thus can be combined in an optimal way. Using the SIGNAL-field as another long training symbol is therefore a feasible solution, since the chance of a good reception is very high.

It is to be understood that the embodiments and variations shown and described herein are merely illustrative of the principles of this invention and that various modifications may be implemented by those skilled in the art without departing from the scope and spirit of the invention.

We claim:

1. A method for transmitting data in a multiple antenna communication system having N transmit antennas, said method comprising the step of:
transmitting a legacy preamble having at least one long training symbol, and at least one additional long training symbol on each of said N transmit antennas, each of said long training symbols having a plurality of subcarriers, wherein said subcarriers are grouped into a plurality of subcarrier groups, and wherein each subcarrier group is transmitted on a different transmit antenna in a given time interval.

2. The method of claim 1, wherein said grouped is based on a blocking technique.

3. The method of claim 1, wherein said grouped is based on an interleaving technique.

4. The method of claim 1, wherein each of said transmit antennas transmits a total of N long training symbols.

5. The method of claim 4, wherein said subcarrier groups transmitted by a given transmit antenna are varied for each of the N long training symbols transmitted by said given transmit antenna.

6. The method of claim 5, wherein after transmission of said N long training symbols by each of said N transmit antennas, each of said N transmit antennas has transmitted each subcarrier of said long training symbols only once.

7. The method of claim 1, wherein a sequence of each of said long training symbols on each of said N transmit antennas are orthogonal.

8. The method of claim 1, wherein said legacy preamble further comprises at least one short training symbol.

9. The method of claim 1, wherein said legacy preamble further comprises at least one SIGNAL field.

10. The method of claim 1, wherein said legacy preamble is an 802.11 a/g preamble.

11. The method of claim 1, wherein each of said long training symbols are orthogonal in the frequency domain.

12. The method of claim 1, wherein N is two and wherein said transmitting step further comprises the step of transmitting a legacy preamble having at least one long training symbol and one additional long training symbol on each of said two transmit antennas, wherein half of the subcarriers of the long training symbol are in a first subcarrier group and the remaining half of the subcarriers of the long training symbol are in a second subcarrier group

13. The method of claim 1, whereby a lower order receiver can interpret said transmitted data.

14. The method of claim 1, further comprising the step of transmitting a field indicating said number N of transmit antennas.

15. A transmitter in a multiple antenna communication system, comprising:
N transmit antennas for transmitting a legacy preamble having at least one long training symbol, and at least one additional long training symbol on each of said N transmit antennas, each of said long training symbols having a plurality of subcarriers, wherein said subcarriers are grouped into a plurality of subcarrier groups, and wherein each subcarrier group is transmitted on a different transmit antenna in a given time interval.

16. The transmitter of claim 15, wherein said grouped is based on a blocking technique.

17. The transmitter of claim 15, wherein said grouped is based on an interleaving technique.

18. The transmitter of claim 15, wherein each of said transmit antennas transmits a total of N long training symbols.

19. The transmitter of claim 18, wherein said subcarrier groups transmitted by a given transmit antenna are varied for each of the N long training symbols transmitted by said given transmit antenna.

20. The transmitter of claim 19, wherein after transmission of said N long training symbols by each of said N transmit antennas, each of said N transmit antennas has transmitted each subcarrier of said long training symbols only once.

21. The transmitter of claim 15, wherein a sequence of each of said long training symbols on each of said N transmit antennas are orthogonal.

22. The transmitter of claim 15, wherein said legacy preamble further comprises at least one SIGNAL field.

23. The transmitter of claim 15, wherein said legacy preamble is an 802.11 a/g preamble.

24. The transmitter of claim 15, wherein each of said long training symbols are orthogonal in the frequency domain.

25. The transmitter of claim 15, wherein N is two and wherein said two transmit antennas transmit a legacy preamble having at least one long training symbol and one additional long training symbol on each of said two transmit antennas, wherein half of the subcarriers of the long training symbol are in a first subcarrier group and the remaining half of the subcarriers of the long training symbol are in a second subcarrier group

26. The transmitter of claim 15, whereby a lower order receiver can interpret said transmitted data.

27. A method for receiving data on at least one receive antenna transmitted by a transmitter having N transmit antennas in a multiple antenna communication system, said method comprising the steps of:
receiving a legacy preamble having at least one long training symbol and an indication of a duration of a transmission of said data, and at least one additional long training symbols on each of said N transmit antennas, each of said long training symbols having a plurality of subcarriers, wherein said subcarriers are grouped into a plurality of subcarrier groups, and wherein each subcarrier group is transmitted on a different transmit antenna in a given time interval; and
deferring for said indicated duration.

28. The method of claim 27, wherein said method is performed by a SISO receiver.

29. The method of claim 27, wherein said indication is transmitted in a SIGNAL field that complies with the 802.11 a/g standards.

30. A receiver in a multiple antenna communication system having at least one transmitter having N transmit antennas, comprising:
at least one receive antenna for receiving a legacy preamble having at least one long training symbol and an indication of a duration of a transmission of said data, and N-1 additional long training symbols on each of said N transmit antennas, each of said long training symbols having a plurality of subcarriers, wherein said subcarriers are grouped into a plurality of subcarrier groups, and wherein each subcarrier group is transmitted on a different transmit antenna in a given time interval; and
means for deferring for said indicated duration.
